(19) United States
(12) Patent Application Publication
(10) Pub. No.: US 2025/0309539 A1
(43) Pub. Date: Oct. 2, 2025

(54) ANTENNA SUBSTRATE, ELECTRONIC PACKAGE AND MANUFACTURING METHOD THEREOF

(71) Applicant: SILICONWARE PRECISION INDUSTRIES CO., LTD., Taichung City (TW)

(72) Inventors: I-Hsien LIN, Taichung City (TW); Yu-Min LO, Taichung City (TW); Chih-Chun YANG, Taichung City (TW); Mu-Hsuan CHAN, Taichung City (TW)

(21) Appl. No.: 18/882,213

(22) Filed: Sep. 11, 2024

(30) Foreign Application Priority Data
Apr. 2, 2024 (TW) 113112562

(51) Int. Cl. H01Q 9/04; H01Q 1/38; H01Q 1/42; H01Q 21/06

(52) U.S. Cl. CPC H01Q 9/0407; H01Q 1/422; H01Q 21/065; H01Q 1/38

(57) ABSTRACT

An antenna substrate, electronic package and manufacturing method thereof are provided in which an antenna substrate including a silicon core layer, a circuit structure and conductive pillars, and the circuit structure has a first dielectric layer, a first circuit layer and a first antenna portion. The circuit structure and the conductive pillars are formed on opposite sides of the silicon core layer, and the antenna substrate is stacked and bonded to a circuit board having a second antenna portion through the conductive pillars. Thereby, the present disclosure can thin a thickness of the antenna substrate and the electronic package, or precisely control a distance between the antenna substrate and the circuit board.

### CROSS-REFERENCE TO RELATED APPLICATIONS

The present application is based upon and claims the right of priority to TW patent application Ser. No. 11/311,2562, filed Apr. 2, 2024, the disclosure of which is hereby incorporated by reference herein in its entirety for all purposes.

### BACKGROUND

### 1. Technical Field

The present disclosure relates to a semiconductor device packaging technology, and more particularly, to an electronic package with an antenna substrate and manufacturing method thereof.

### 2. Description of Related Art

At present, wireless communication technology has been widely applied into various consumer electronic products to facilitate the reception or transmission of various wireless signals, in order to satisfy the appearance design requirements of consumer electronic products, the manufacturing and design of wireless communication modules have been developed to meet the requirements of being light, thin, short, and small, wherein the patch antenna has been widely used in wireless communication modules of electronic products such as cell phones because of its characteristics of small dimension, light weight and easy to manufacture.

However, the bandwidth of the traditional patch antenna is too narrow, such that another patch antenna is often added directly above the patch antenna to provide additional resonant frequency in practical applications. After proper designs, the additional resonant frequency is moved to the vicinity of the lower patch antenna to have a total of two resonant points, so as to increase the bandwidth of the antenna.

FIG. 1 is a schematic cross-sectional view of a conventional wireless communication module 1. As shown in FIG. 1, in a wireless communication module 1, a circuit board 10 with a semiconductor chip 11 is stacked with an antenna substrate 12 thereon by a plurality of solder balls 13 (or support bumps). The circuit board 10 has an antenna portion 100 formed on an upper side thereof, and the antenna portion 100 can be electrically coupled to the antenna layer 120 above the antenna substrate 12 to transmit and/or receive related telecommunications (such as wireless signals).

For applications to lower frequency bands, such as 28 GHz for 5G (5^{th} generation) mobile communications, the antenna layer 120 and the antenna portion 100 of the wireless communication module 1 use the air as the medium, so an air area A as an air gap is required to be defined in a specific area between the circuit board 10 and the antenna substrate 12. Besides, the air area A is located in an area between the circuit board 10 and the antenna substrate 12 supported by solder balls 13, and no glue or molding filler is allowed inside. Meanwhile, by controlling a distance H between the circuit board 10 and the antenna substrate 12 to ensure the quality of the transmission/reception signal between the antenna layer 120 and the antenna portion 100, and to control the accuracy of the distance H through the support of solder balls 13.

However, the antenna substrate 12 is a core substrate with a metal layer, such that the rigidity of the antenna substrate 12 is sufficient to avoid deformation and causing the distance H of the air area A as the air gap to be inconsistent. However, the disadvantage of which is that the thickness of the antenna substrate 12 cannot be decreased.

Additionally, by controlling the distance H through solder balls 13, there is a risk that the solder material will melt if the structure is heated, causing the distance H to change, which results in poor quality of transmission/reception signals.

Moreover, the large tolerance of the solder ball 13 may make the distance H difficult to control. Besides, when using solder balls 13, epoxy resin 14 (or dispensing) required to be used to conduct corner bond of the antenna substrate 12, so that the antenna substrate 12 can be firmly disposed on the circuit board 10, resulting in additional process, material, and cost of epoxy resin 14 (or dispensing).

Therefore, there is a need for a solution that addresses the aforementioned shortcomings in the prior art.

### SUMMARY

In view of the aforementioned shortcomings of the prior art, the present disclosure provides an antenna substrate, which comprises: a silicon core layer having a first side and a second side opposing to the first side; a circuit structure formed on the first side of the silicon core layer, and having at least a first dielectric layer, at least a first circuit layer bonded to the first dielectric layer and a first antenna portion electrically connected to the first circuit layer; and a plurality of conductive pillars formed on the second side of the silicon core layer.

The present disclosure also provides a manufacturing method of an antenna substrate, which comprises: providing a silicon core layer having a first side and a second side opposing the first side to form a circuit structure on the first side of the silicon core layer, wherein the circuit structure has at least a first dielectric layer, at least a first circuit layer bonded to the first dielectric layer and a first antenna portion electrically connected to the first circuit layer; and forming a plurality of conductive pillars on the second side of the silicon core layer.

The present disclosure further provides an electronic package, which comprises: the aforementioned antenna substrate; and a circuit board having a second antenna portion, wherein the antenna substrate is stacked on and bonded to the circuit board by the second antenna portion thereof via a plurality of conductive pillars.

The present disclosure also provides a method of manufacturing an electronic package, which comprises: providing the aforementioned antenna substrate; and stacking and bonding the antenna substrate onto a second antenna portion of a circuit board through the plurality of conductive pillars.

In the aforementioned antenna substrate and manufacturing method thereof, the circuit structure has a plurality of the first dielectric layers and a plurality of the first circuit layers, and the first antenna portion directly formed on an outermost one of the first dielectric layers and an outermost one of the first circuit layers.

In the aforementioned antenna substrate and manufacturing method thereof, the first circuit layer is a fan-out redistribution circuit layer, and the first circuit layer is served as an antenna trace or an antenna extension of the first antenna portion.

In the aforementioned antenna substrate and manufacturing method thereof, further comprising a plurality of bonding materials formed on an end of the plurality of conductive pillars.

In the aforementioned antenna substrate and manufacturing method thereof, further comprising a second dielectric layer formed on the second side of the silicon circuit layer.

In the aforementioned electronic package and manufacturing method thereof, an air area served as an air gap is formed between the antenna substrate and the circuit board, and the antenna substrate and the circuit board are separated by a distance by the plurality of conductive pillars.

In the aforementioned electronic package and manufacturing method thereof, the antenna substrate further comprises a second circuit layer formed in or on the surface of the second dielectric layer, and the plurality of conductive pillars are formed in the second dielectric layer or on the second circuit layer to be electrically connected to the second circuit layer.

In the aforementioned electronic package and manufacturing method thereof, the circuit board further has a third circuit layer, for the plurality of conductive pillars to be bonded to or electrically connected to the third circuit layer.

In the aforementioned electronic package and manufacturing method thereof, the circuit board further has a fourth circuit layer, both the second antenna portion and the third circuit layer are formed on a first surface of the circuit board, and the fourth circuit layer is formed on a second surface of the circuit board.

As can be understood from the above, in the antenna substrate, electronic package and manufacturing method thereof of the present disclosure, the antenna substrate comprises a circuit structure with a first antenna portion, and silicon (such as silicon wafer) is served as the silicon core layer, and the rigidity of the silicon core layer is sufficient, such that the thickness of the antenna substrate can be thinned, and the entire thickness of the antenna substrate and the electronic package become thinner.

Furthermore, in the electronic package of the present disclosure, the conductive pillars (such as copper pillars) support the antenna substrate above and the circuit board below, so it can accurately control the distance of the air area (such as air gap) between the antenna substrate and the circuit board, such that the electronic package is prevented from being affected by heat and causing poor quality of transmission/reception signals between the first antenna portion and the second antenna portion.

In addition, in the present disclosure, the conductive pillars (such as copper pillars) support the distance of the air area (such as air gap) between the antenna substrate and the circuit board, thus it prevents conductive pillars from being deformed by heat, and can eliminate the material/cost of epoxy resin (or glue dispensing) and the process of corner bond of the conventional wireless communication module.

### BRIEF DESCRIPTION OF THE DRAWINGS

FIG. 1 is a schematic cross-sectional view of a conventional wireless communication module.

FIG. 2A to FIG. 2D are schematic cross-sectional views of a manufacturing method of an antenna substrate of the present disclosure.

FIG. 2E is a schematic cross-sectional view of a manufacturing method of an electronic package of the present disclosure.

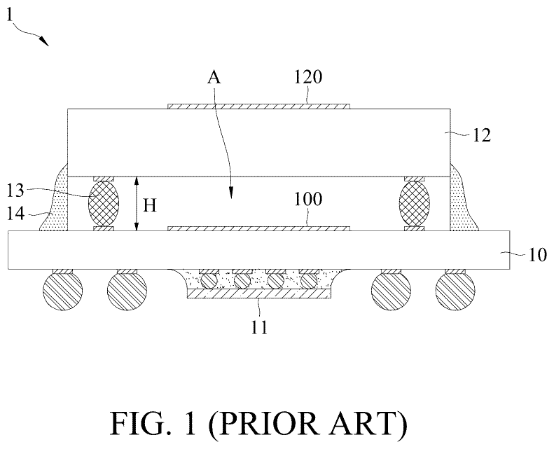

### DETAILED DESCRIPTION

The following describes the implementation of the present disclosure with examples. Those skilled in the art can easily understand other advantages and effects of the present disclosure from the contents disclosed in this specification.

It should be understood that, the structures, ratios, sizes, and the like in the accompanying figures are used for illustrative purposes to facilitate the perusal and comprehension of the contents disclosed in the present specification by one skilled in the art, rather than to limit the conditions for practicing the present disclosure. Any modification of the structures, alteration of the ratio relationships, or adjustment of the sizes without affecting the possible effects and achievable proposes should still be deemed as falling within the scope defined by the technical contents disclosed in the present specification. Meanwhile, terms such as “on,” “under,” “one,” “two,” “first,” “second,” “third,” and the like are merely used for clear explanation rather than limiting the practicable scope of the present disclosure, and thus, alterations or adjustments of the relative relationships thereof without essentially altering the technical contents should still be considered in the practicable scope of the present disclosure.

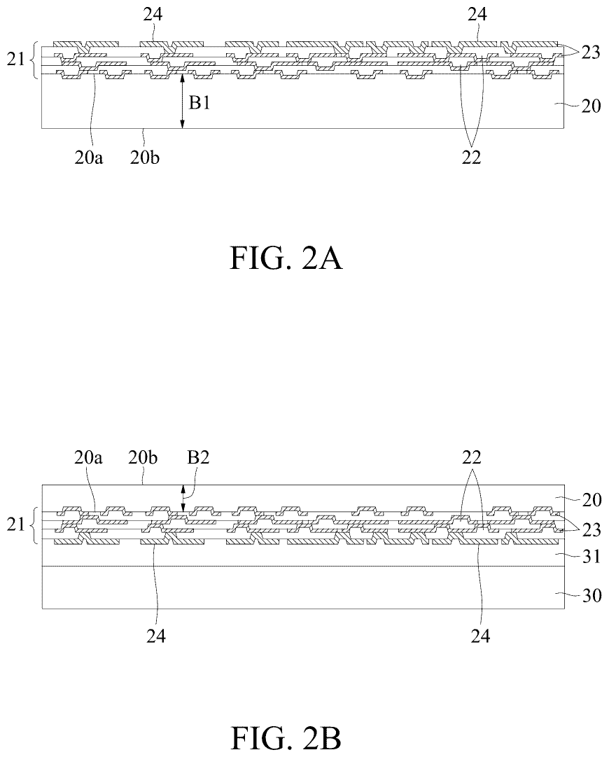

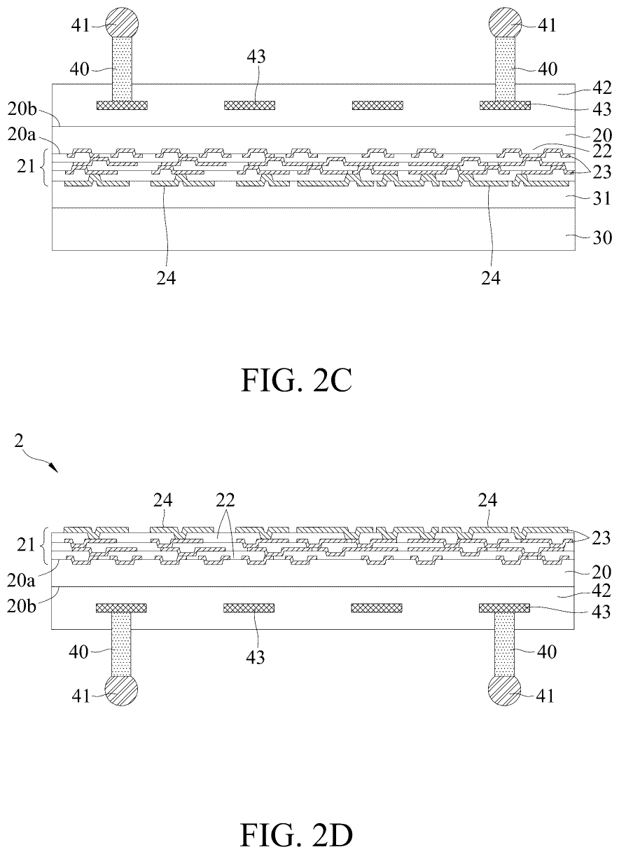

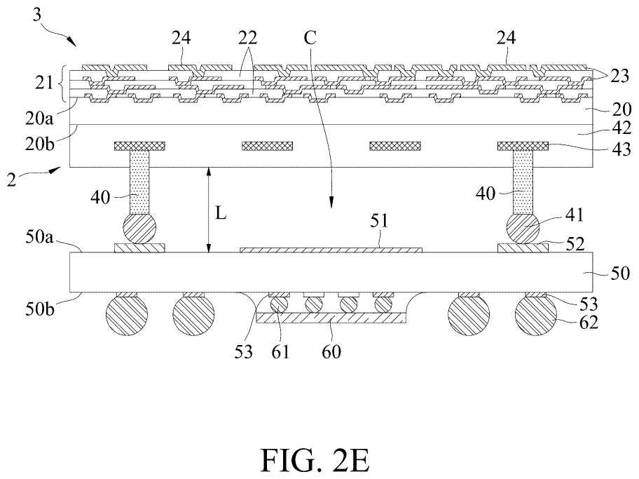

FIG. 2A to FIG. 2D are schematic cross-sectional views of a manufacturing method of an antenna substrate 2 of the present disclosure, and FIG. 2D to FIG. 2E are schematic cross-sectional views of a manufacturing method of an electronic package 3 of the present disclosure. Meanwhile, “at least one” described in the present disclosure represents at least one (such as one, two, or three), and “a plurality of” described in the present disclosure represents at least two (such as two, three, four, or more than ten).

As shown in FIG. 2A, providing a silicon core layer 20 (such as silicon material) with a first side 20a and a second side 20b opposing the first side 20a to form a circuit structure 21 on the first side 20a of the silicon core layer 20, and the circuit structure 21 can have at least one first dielectric layer 22, at least one first circuit layer 23 bonded to the first dielectric layer 22 and a first antenna portion 24 electrically connected to the first circuit layer 23.

In an embodiment, the circuit structure 21 may have a plurality (such as at least two or three layers) of first dielectric layers 22, a plurality (such as at least two or three layers) of first circuit layers 23 and a first antenna portion 24 (such as first antenna), and an outermost (such as the uppermost) first antenna layer 23 can be electrically connected to the first antenna portion 24. The first antenna portion 24 can be formed directly on an outermost (such as the uppermost) first dielectric layer 22 and first circuit layer 23 and exposed out from the first dielectric layer 22, that is, the first antenna portion 24 is not covered by the first dielectric layer 22.

In an embodiment, the first dielectric layer 22 can be an insulating layer, etc., the first circuit layer 23 can be a fan-out redistribution layer (RDL), etc., and the first circuit layer 23 can be served as an antenna trace or an antenna extension of the first antenna portion 24.

As shown in FIG. 2B, turning the silicon core layer 20 and the circuit structure 21 shown in FIG. 2A upside down, so as to bond the circuit structure 21 to a release layer 31 of a carrier 30.

Then, part of material of silicon core layer 20 is removed by, for example, grinding, so as to thin a thickness B1 (see FIG. 2A) to an appropriate thickness B2 (see FIG. 2B) of the silicon core layer 20 according to actual requirement, that is, the thickness B2 is smaller than the thickness B1. Yet in other embodiments, in the manufacturing method of FIG. 2A, the silicon core layer 20 is directly provided with an appropriate thickness B2 but without thin the thickness B1 of the silicon core layer 20 through grinding.

As shown in FIG. 2C, a plurality of conductive pillars 40 are formed on the second side 20b of the silicon core layer 20, and also a plurality of bonding materials 41 are further formed on ends of the plurality of conductive pillars 40.

In an embodiment, a second dielectric layer 42 and a second circuit layer 43 bonded to the second dielectric layer 42 can be firstly formed on the second side 20b of the silicon core layer 20, and the plurality of conductive pillars 40 are then formed in the second dielectric layer 42 or on the second circuit layer 43 to be electrically connected to the second circuit layer 43, and the second circuit layer 43 can be formed in the second dielectric layer 42 or on the surface (such as the outer surface or the upper surface) of the second dielectric layer 42.

In an embodiment, conductive pillars 40 can be copper pillars, etc., bonding materials 41 can be conductive materials, etc., the second dielectric layer can be an insulating layer.

As shown in FIG. 2D, turning the silicon core layer 20, the circuit structure 21, the conductive pillars 40, the bonding materials 41, the second dielectric layer 42 and the second circuit layer 43 and other components shown in FIG. 2C upside down to remove the carrier 30 and the release layer 31 thereof on the circuit structure 21 shown in FIG. 2C, so as to obtain the antenna substrate 2 of the present disclosure.

As shown in FIG. 2E, a circuit board 50 having a second antenna portion 51 (such as second antenna) and a third circuit layer 52 is provided, and the antenna substrate 2 shown in FIG. 2D is disposed, stacked and bonded to the circuit board 50 through the plurality of conductive pillars 40, so as to obtain the electric package 3 (such as the packaging structure or the wireless communication module) of the present disclosure.

In an embodiment, the plurality of conductive pillars 40 can be directly bonded or electrically connected to the third circuit layer 52 of the circuit board 50. However, in other embodiments, the plurality of conductive pillars 40 can also be bonded or electrically connected to the third circuit layer 52 of the circuit board 50 through the plurality of bonding materials 41.

In an embodiment, an air area C served as an air gap can be formed between the antenna substrate 2 (such as the second dielectric layer 42) and the circuit board 50, and the antenna substrate 2 (such as the second dielectric layer 42) and the circuit board 50 are separated by a distance L by the plurality of conductive pillars 40. The air area C is located between the antenna substrate 2 and the circuit board 50 supported by the plurality of conductive pillars 40, and there is substantially no glue or molding filler (such as packaging material) inside the air area C.

In an embodiment, the second antenna portion 51 is electrically coupled to the first antenna portion 24 to send and/or receive related telecommunications (such as wireless signals).

In an embodiment, the circuit board 50 can also have a first surface 50a and a second surface 50b to opposing the first surface 50a, and a fourth antenna layer 53, both the second antenna portion 51 and the third circuit layer 52 can be formed on the first surface 50a of the circuit board 50, and the fourth circuit layer 43 can be formed on the second surface 50b of the circuit board 50.

In an embodiment, the electronic package 3 can also comprise at least one (such as a plurality of) electronic element 60 and a plurality of solder balls 62, etc., the electronic element 60 can be electrically connected to the fourth circuit layer 53 of the circuit board 50 through a plurality of conductive bumps 61, and the plurality of solder balls 62 can be formed on the fourth circuit layer 53 of the circuit board 50, such that the circuit board 50 is further bonded to the electronic structure of the circuit board or another circuit board (not shown) by reflowing the plurality of solder balls 62.

Furthermore, although the electronic element 60 is not disposed between the antenna substrate 2 and the circuit board 50, there are various arrangements (such as being disposed on the first surface 50a of the circuit board 50) of related electronic element 60, and the present disclosure is not limited to as such.

In an embodiment, the electronic element 60 can be an active element, a passive element, or a combination thereof, the active element can be a semiconductor chip, etc., and the passive element can be a resistor, a capacitor, and/or an inductor, etc. For instance, the electronic element 60 can be electrically connected to the fourth circuit layer 53 of the circuit board 50 in a flip-chip manner by the plurality of conductive bumps 61 made of solder material. Alternatively, the electronic element 60 can be electrically connected to the fourth circuit layer 53 of the circuit board 50 in a wire bonding manner by a plurality of solder wires (not shown). Alternatively, the electronic element 60 can be directly contacted to the circuit board 50 to be electrically connected to the fourth circuit layer 53. However, the way which the electronic element 60 electrically connected to the circuit board 50 or the fourth circuit layer 53 is not limited to the above.

The present disclosure also provides an antenna substrate 2, the antenna substrate 2 comprises: a silicon core layer 20 having a first side 20a and a second side 20b opposing to the first side 20a; a circuit structure 21 formed on the first side 20a of the silicon core layer 20, and the circuit structure 21 having at least one first dielectric layer 22, at least one first circuit layer 23 bonded to the first dielectric layer 22 and a first antenna portion 24 electrically connected to the first circuit layer 23; and a plurality of conductive pillars 40 formed on the second side 20b of the silicon core layer 20.

In an embodiment, the circuit structure 21 having a plurality of first dielectric layers 22 and a plurality of first circuit layers 23, and the first antenna portion 24 directly formed on the outermost first dielectric layer 22 and first circuit layer 23.

In an embodiment, the first circuit layer 23 is a fan-out redistribution circuit layer, and the first circuit layer 23 is served as the antenna trace or the antenna extension of the first antenna portion 24.

In an embodiment, the antenna substrate 2 can also comprise a plurality of bonding materials 41 formed on the ends of the plurality of conductive pillars 40.

In an embodiment, the antenna substrate 2 can also comprise a second dielectric layer 42 formed on the second side 20b of the silicon circuit layer 20.

The present disclosure further provides an electronic package 3, the electronic package 3 comprises: the aforementioned antenna substrate 2; and a circuit board 50 having a second antenna portion 51, and the antenna substrate 2 is stacked and bonded to the circuit board 50 with the second antenna portion 51 through a plurality of conductive pillars 40.

In an embodiment, an air area C served as an air gap is formed between the antenna substrate 2 and the circuit board 50, and the antenna substrate 2 and the circuit board 50 separated by a distance L by the plurality of conductive pillars 40.

In an embodiment, the antenna substrate 2 can also comprise a second circuit layer 43 formed in or on the surface of the second dielectric layer 42, and the plurality of conductive pillars 40 are formed in the second dielectric layer 42 or on the second circuit layer 43 to be electrically connected to the second circuit layer 43.

In an embodiment, the circuit board 50 can also have a third circuit layer 52, and the plurality of conductive pillars 40 bonded or electrically connected to the third circuit layer 52.

In an embodiment, the circuit board 50 can also have a fourth circuit layer 53, both the second antenna portion 51 and the third circuit layer 52 are formed on a first surface 50a of the circuit board 50, and the fourth circuit layer 53 is formed on a second surface 50b of the circuit board 50.

Thus, the antenna substrate 2, the electronic package 3 and manufacturing methods thereof of the present disclosure at least have the following features, advantages or technical effects.
1. The antenna substrate 2 of the present disclosure comprising a circuit structure 21 with a first antenna portion 24, and silicon base material is served as the silicon core layer 20, and the rigidity of the silicon core layer 20 is sufficient, such that the thickness of the antenna substrate 2 can be thinned, and the entire thickness of the antenna substrate 2 and the electronic package 3 become thinner.
2. In the electronic package 3 of the present disclosure, the conductive pillars 40 (such as copper pillars) support the antenna substrate 2 above and the circuit board 50 below, so it can accurately control the distance L of the air area C (such as air gap) between the antenna substrate 2 and the circuit board 50, such that the electronic package 3 is prevented from being affected by heat and causing poor quality of transmission/reception signals between the first antenna portion 24, the second antenna portion 51 and/or the electronic element 60.
3. In the present disclosure, the conductive pillars 40 (such as copper pillars) support the antenna substrate 2 and the circuit board 50 to provide the distance L of the air area C (such as air gap) therebetween, thus the conductive pillars 40 are prevented from being deformed by heat, and can eliminate the material/cost of epoxy resin (or dispensing) and the process of corner bond of the conventional wireless communication module.
4. The manufacturing processes of the antenna substrate 2 and the electronic package 3 of the present disclosure are simple, thus the implementations are convenient, such that there is no need to purchase expensive machines and spend amount of additional cost or time.

The above embodiments are provided for illustrating the principles of the present disclosure and its technical effect, and should not be construed as to limit the present disclosure in any way. The above embodiments can be modified by one of ordinary skill in the art without departing from the spirit and scope of the present disclosure. Therefore, the scope claimed of the present disclosure should be defined by the following claims.

What is claimed is:

1. An antenna substrate, comprising:
a silicon core layer having a first side and a second side opposing the first side;
a circuit structure formed on the first side of the silicon core layer, and having at least a first dielectric layer, at least a first circuit layer bonded to the first dielectric layer and a first antenna portion electrically connected to the first circuit layer; and
a plurality of conductive pillars formed on the second side of the silicon core layer.

2. The antenna substrate of claim 1, wherein the circuit structure has a plurality of the first dielectric layers and a plurality of the first circuit layers, and the first antenna portion is directly formed on an outermost one of the first dielectric layers and an outermost one of the first circuit layers.

3. The antenna substrate of claim 1, wherein the first circuit layer is a fan-out redistribution circuit layer, and the first circuit layer is served as an antenna trace or an antenna extension of the first antenna portion.

4. The antenna substrate of claim 1, further comprising a plurality of bonding materials formed on ends of the plurality of conductive pillars.

5. The antenna substrate of claim 1, further comprising a second dielectric layer formed on the second side of the silicon circuit layer.

6. A method of manufacturing an antenna substrate, comprising:
providing a silicon core layer having a first side and a second side opposing the first side and forming a circuit structure on the first side of the silicon core layer, wherein the circuit structure has at least a first dielectric layer, at least a first circuit layer bonded to the first dielectric layer and a first antenna portion electrically connected to the first circuit layer; and
forming a plurality of conductive pillars on the second side of the silicon core layer.

7. The method of claim 6, wherein the circuit structure has a plurality of the first dielectric layers and a plurality of the first circuit layers, and the first antenna portion is directly formed on an outermost one of the first dielectric layers and an outermost one of the first circuit layers.

8. The method of claim 6, wherein the first circuit layer is a fan-out redistribution circuit layer, and the first circuit layer is served as an antenna trace or an antenna extension of the first antenna portion.

9. The method of claim 6, further comprising a plurality of bonding materials formed on ends of the plurality of conductive pillars.

10. The method of claim 6, further comprising a second dielectric layer formed on the second side of the silicon circuit layer.

11. An electronic package, comprising:
an antenna substrate of claim 1; and
a circuit board having a second antenna portion, wherein the antenna substrate is stacked on and bonded to the circuit board by the second antenna portion thereof via a plurality of conductive pillars.

12. The electronic package of claim 11, wherein an air area served as an air gap is formed between the antenna substrate and the circuit board, and the antenna substrate and the circuit board are separated by a distance by the plurality of conductive pillars.

13. The electronic package of claim 11, wherein the second side of the silicon core layer is formed with a second dielectric layer thereon, the antenna substrate further comprises a second circuit layer formed in or on a surface of the second dielectric layer, and the plurality of conductive pillars are formed in the second dielectric layer or on the second circuit layer to be electrically connected to the second circuit layer.

14. The electronic package of claim 13, wherein the circuit board further has a third circuit layer, for the plurality of conductive pillars to be bonded or electrically connected to the third circuit layer.

15. The electronic package of claim 14, wherein the circuit board further has a fourth circuit layer, both the second antenna portion and the third circuit layer are formed on a first surface of the circuit board, and the fourth circuit layer is formed on a second surface of the circuit board.

16. A method of manufacturing an electronic package, comprising:
providing an antenna substrate of claim 1; and
stacking and bonding the antenna substrate onto a second antenna portion of a circuit board through the plurality of conductive pillars.

17. The method of claim 16, wherein an air area served as an air gap is formed between the antenna substrate and the circuit board, and the antenna substrate and the circuit board are separated by a distance by the plurality of conductive pillars.

18. The method of claim 16, wherein the second side of the silicon core layer is formed with a second dielectric layer thereon, the antenna substrate further comprises a second circuit layer formed in or on a surface of the second dielectric layer, and the plurality of conductive pillars are formed in the second dielectric layer or on the second circuit layer to be electrically connected to the second circuit layer.

19. The method of claim 18, wherein the circuit board further has a third circuit layer, and the plurality of conductive pillars are bonded or electrically connected to the third circuit layer.

20. The method of claim 19, wherein the circuit board further has a fourth circuit layer, both the second antenna portion and the third circuit layer are formed on a first surface of the circuit board, and the fourth circuit layer is formed on a second surface of the circuit board.
